(19) United States
(12) Patent Application Publication
(10) Pub. No.: US 2005/0074047 A1
(43) Pub. Date: Apr. 7, 2005

(54) Laser with life saver mode

(76) Inventors: Richard Boggy, Sunnyvale, CA (US); Kevin Holsinger, Menlo Park, CA (US)

Correspondence Address: HELLER EHRMAN WHITE & MCAULIFFE LLP, 275 MIDDLEFIELD ROAD, MENLO PARK, CA, 94025-3506, US

(21) Appl. No.: 10/637,811

(22) Filed: Aug. 7, 2003

Related U.S. Application Data
(60) Provisional application No. 60/401,922, filed on Aug. 7, 2002.

(51) Int. Cl. H01S 3/09

(52) U.S. Cl. 372/69; 372/70; 372/66

(57) ABSTRACT

Described herein is a laser system with an output coupler and high reflector that defines a resonator cavity. In an embodiment of the invention, a gain medium is positioned in the resonator cavity, producing an intracavity beam in response to a fixed pump beam. The gain medium has an optical face with a preferred region where the pump beam overlaps optically with the intracavity laser. The gain medium movement member is coupled to the gain medium to move the preferred region in a direction parallel to the pumped face to maintain optimal mode matching conditions.

### CROSS-REFERENCE TO RELATED APPLICATIONS

This application claims the benefit of provisional Application Ser. 60/401,922 filed Aug. 7, 2002, which application is fully incorporated herein.

### FIELD OF THE INVENTION

The present invention relates generally to prolonging the useful life of an optical element contained within sealed environment and subject to irradiation by intense laser beam, and more particularly to optimizing long term operation of tunable laser materials pumped by the focused radiation of another laser beam.

### BACKGROUND OF THE INVENTION

Laser induced damage is a well known process limiting the lifetime of optical elements subject to irradiation by intense laser beams. Thus, when an optical element is intensively irradiated by a laser beam, its performance tends to degrade over time, with the likelihood of damage accelerating the higher are the laser intensity and the average power. Consequently, laser induced damage to critical optical elements is a major practical limitation to power scaling in laser systems. The damage itself is generally a complicated phenomenon, depending on numerous factors including laser peak power, energy, wavelength, the presence of any hot spots in the beam, the optical element surface quality and even specifics of techniques for applying protective coatings. For example, the damage is known to accelerate at shorter wavelengths and is further facilitated by the presence of defects, imperfections or contaminants on the element, all of which can form absorption and scattering centers, resulting in power and beam quality degradations.

The literature is especially familiar with damage to non-linear materials because the nonlinear conversion process tends to require beams focussed to small spots in order to provide the high power densities necessary for high conversion efficiencies. In operation, non linear materials are subject to a variety of laser induced damage mechanisms attributed, among others, to a host of thermal, photo-acoustic and plasma effects. The damage can occur on the element's surface, on the protective coating or in the bulk of the material itself. Coatings for example are especially susceptible to UV wavelengths and these are known to have relatively low damage thresholds.

Over the past decade, techniques to extend the usable lifetime of nonlinear materials employed in frequency conversion processes within high power laser systems have been suggested, centering typically on extending the number of usable spots in the material. This can be achieved by translating the material with respect to the incident beam so that a new spot is exposed to the laser beam when one is “used up”. Currently, commercial systems such as Spectra-Physics' Vanguard, Navigator and Y-Series, employ external frequency conversion of radiation from high power lasers into the UV include provisions for translating the third or fourth harmonic crystal such that new spots are successively exposed, once a given spot shows signs of degradation. Generally, such techniques allow extending the lifetime of the crystal in direct proportion to the number of available spots on a crystal. More sophisticated techniques for extending the usable life of crystals are also known. For example, Marason et al in U.S. Pat. No. 5,179,562 provided a technique for moving a crystal continually through an intracavity CW laser beam while maintaining optimal conversion efficiency levels. Lai et al in U.S. Pat. No. 5,825,562 teach means and method for prolonging the usage life of nonlinear optical elements, subjected to irradiation by an intense laser beams by employing a two-dimensional continuous relative motion between the element and the laser beam while maintaining the axial crystal orientation, thereby increasing the effective interaction area of the crystal and maintaining the preferred phase matching conditions.

Laser induced damage to nonlinear materials is a well known effect, it is less well known that linear gain materials and passive optical elements can also suffer from long term degradations under exposure to high powers. This is especially true in the case of laser pumped lasers as in the case of tunable materials such as Ti:sapphire, Co:MgF2 and Ce:LiSAF. Typical in the art of laser pumped Ti:sapphire laser is U.S. Pat. No. 4,894,831 to Alfrey which discloses a Ti:sapphire gain medium being longitudinally pumped by the CW beam from an Argon ion laser which is focussed by a set of curved mirrors into a gain material cut at Brewster angles. This patent further teaches an alignment apparatus designed to maintain optimal mode matching between the pump and the cavity mode while compensating for astigmatism and depolarization effects of any misalignment to thereby achieve a greater tuning range with good reliability.

A particular mechanism affecting the performance of solid state materials used in such longitudinally pumped lasers is the phenomenon of laser beam trapping of particles and molecules. This mechanism has been extensively studied by Ashkin and co-workers (see for example U.S. Pat. No. 4,893,886) especially with regard to the technique known as “laser tweezers” used to precisely position trapped particles. Recently, as described in OPN July 2003 pages 16-17, the same phenomenon was identified as responsible driving oil droplets to the surface of a mirror in the laser cavity, where they were subsequently trapped. Thus, molecules and particulates that drift into the path of a focused laser beam experience a force that drives them toward the beam's waist. In the case of laser pumped lasers, particulates and molecular contaminants which may be present in the cavity or are generated by outgassing can be trapped by either or both the intense pump or intracavity laser beams and are effectively accelerated towards the face of the optical surface of the gain material where they are deposited. Over time these contaminants will cause losses due to absorption and scatter of the intracavity beam. The loss is manifest as a decrease in power of the laser output, distortion of the spatial mode of the output beam and/or power and energy instabilities. Consequently, whenever intense beams are focussed onto a material, laser beam trapping phenomenon can cause degradation of laser performance, thereby limiting the prospects for long term operation of the system. The degradation can be further exacerbated by build-up of trapped contaminants on other optical surfaces in the cavity that are also subject to the intense radiation.

Proposed solutions included cleaning of the optical surfaces periodically or even replacing the gain material or the affected optical element once the losses become unacceptable. However, this means of regaining laser performance requires use of proper solvents and techniques, making it difficult for the user in the field to employ reliably. Furthermore, in laser systems that are sealed against environmental contaminants, cleaning of the optical surfaces also requires that the seals be broken in order to gain access to the internal surfaces. It is clearly undesirable to execute such a procedure in the field since potential contaminants may be introduced each time the seals are opened.

Alternatively, transverse movement of the gain material may be employed similar to techniques applied to external frequency conversion devices in commercial laser devices (e.g., the Vanguard made by Spectra-Physics). The disadvantage is however that usually the crystal has to be moved while keeping its angle orientation constant at very high precision to ensure optimum mode matching—or in the case of an internal nonlinear device—phase matching. This must be done using relatively expensive translation stages. Alternatively the intracavity beam may be scanned on the surface of the gain material in a manner similar to what was proposed by Koch in PCT Application No. WO 0077890. Koch's technique, however, teaches moving only the pump beam, as it is applicable primarily to nonlinear conversion, where one beam is incident on the face of the element. This method is therefore not applicable to cases where a gain material where the pump and intracavity beams must be moved in tandem. It also does not provide solutions to the case where the critical element is oriented at Brewster's angles and the incident beam's waist must be moved in parallel to the optical face without altering the mode match properties.

Still more sophisticated techniques employing various scanning or translation techniques have been disclosed. For example, Gruber et al in co-pending patent application Ser. No. 10/142,273, incorporated by reference herein, taught more complex spot mapping techniques using algorithms expressly designed to prolong operation at each spot of an element as needed to meet requirements of specific applications. Such algorithms may be ultimately applied to the case of a gain material embedded within a carefully aligned, sealed cavity, which is the subject of the present application but it is recognized that the associated software and hardware control mechanisms can be rather complex and are best applied at advanced stage of the development of a long life laser system.

There is a need to develop methods and systems for extending the useful life of intracavity optical elements contained within sealed enclosures exposed to intense laser beams that are simple to implement, require only minimal additional hardware or software, and are matched to the needs of applications such as semiconductor processing metrology which prefer laser cavities that can remain sealed for long periods of time.

### SUMMARY OF THE INVENTION

Accordingly, an object of the present invention is to provide a system and methods of use for extending the useful life of sensitive intracavity optical elements exposed to intense laser beams without having to open the sealed enclosure containing the laser system.

Another object of the present invention is to provide a laser system that includes a resonator cavity and a gain medium pumped by the focused radiation from a pump laser in a manner allowing operation in a “standby” mode during periods when the laser beam is “off” to thereby extend the lifetime of the gain medium.

A further object of the present invention is to provide a rotatable mirror for directing the pump laser beam onto the gain medium and allowing to move a preferred pump beam face region out of the path of the intracavity beam to thereby interrupt lasing and enter a stand-by mode for a selectable period of “idle” or “off” time.

Still another object of the present invention is to provide a shutter for blocking off the pump beam to thereby interrupt lasing and enter the “stand-by” mode.

Yet another object of the present invention is to provide the gain medium contained within a resonator cavity with a gain movement member configured and adapted to move the gain medium in a direction parallel to the pump face while maintaining optimum overlap conditions with the incident pump beam.

### BRIEF DESCRIPTION OF THE DRAWINGS

FIG. 1 is a schematic diagram of a laser cavity pumped by a focussed beam from another laser.

FIG. 2A-C illustrate the relative positions on the laser rod of the pump and intracavity beams' spatial profiles applicable to the various techniques disclosed in this invention.

FIG. 3 is a schematic of the system with the adjustment mechanism consisting of a PZT controlled mirror and an optional shutter.

FIG. 4 is a schematic diagram of one embodiment of a tunable folded Ti:sapphire laser resonator incorporating a translation mechanism according to principles of the present invention.

### DETAILED DESCRIPTION OF THE PREFERRED EMBODIMENT

In various embodiments the present invention provides methods and means for prolonging the useful life of optical elements subject to irradiation by focused laser beams generated in a laser system that can remain sealed against the environment. In one embodiment the laser comprises a resonator cavity containing a tunable gain element pumped by the focused beam from another laser beam. In other embodiments the resonator cavity may contain non-linear elements designed to shift the radiation from a fundamental beam to alternative wavelengths. Nonlinear processes of interest include Raman shifting, harmonic generation and parametric conversion or any combination thereof using a multiplicity of nonlinear crystals and/or gain media generally contained within the same cavity. In alternate embodiments, the laser system may be operated in a CW, pulsed or mode-locked mode and other elements as are required to produce these modes of operation can be included within the laser cavity. Common to all the embodiments is the presence of a focused pump beam incident upon the optical face of at least one damage prone optical element is as is the need to maintain the integrity of the sealed enclosure for prolonged periods of time.

Suitable laser systems of the present invention may be used in applications that include periodic down times such as may be experienced when the work piece is moved between operations during which time the laser beam is effectively shut off. It is therefore specifically desired to take advantage of these down times to prolong the lifetime of the sensitive optical elements by introducing features that allow operating the laser in a life saver mode that serves to spare the surface of the sensitive element. Additional means and techniques for further prolonging the useful life of the element may be incorporated as needed for a given application, as will be described further in the description.

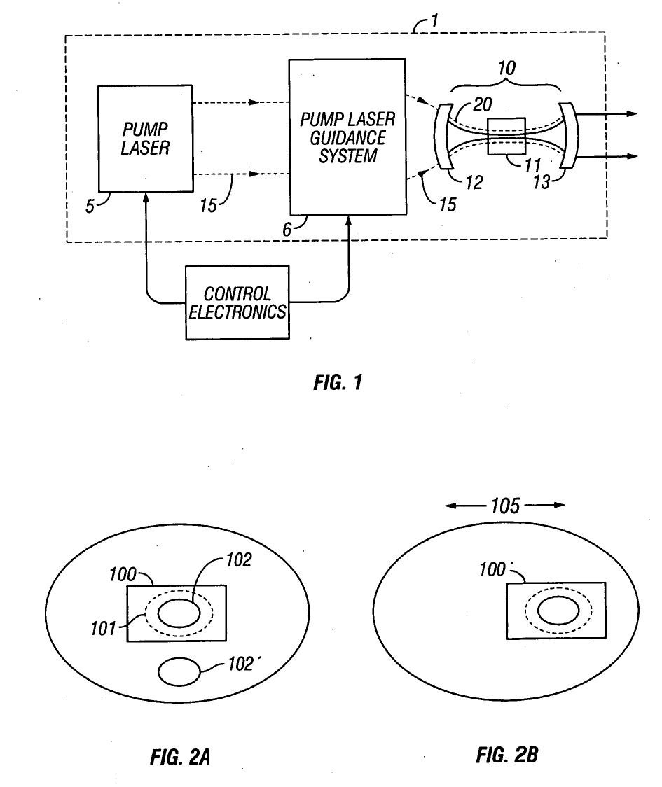

FIG. 1 shows an embodiment where beam 15 from a pump laser 5 is focused into an optical gain material 11 contained within a laser resonator 10 which also generates an intracavity beam 20. The resonator cavity 10 is most generally defined by a high reflector 12 and an output coupler 13 both of which are shown as curved optical elements. In this manner, the intracavity beam 20 is produced such that it has a waist generally located within the gain material 11. Note that although not shown, any number of other elements may be contained within the laser cavity 10 depending on specific application needs. These may include tuning elements such as birefringent filters, modulators, apertures and additional gain or nonlinear elements. The pump beam 15 is guided into the gain material through a suitable combination of optics and other beam manipulation elements generically indicated as pump beam guidance system 6. In this embodiment the pumping laser and the resonator 10 as well as are assumed enclosed in a sealed housing shown by the dashed line 1. An electronic control board 6 is issuing control signals to the pump laser as well as to the pump beam guidance system. The control board may be located outside the sealed housing and may be part of a power supply providing power to the laser system.

As shown in FIG. 1, the gain material 11 is subject to the combined focused illumination from both the pump beam and the intracavity beam. This can increase the potential for laser induced damage due to beam trapping mechanism. Yet, in many applications, including semiconductor processing metrology, the output laser beam is to be shut off during intervals when the work piece is moved or the external beam delivery system is adjusted. It is therefore highly desirable to be able to operate the laser in a “stand by” mode such that during time intervals when laser output is not required the preferred spot on the gain material is spared the cumulative effects of combined irradiation by both pump and intracavity beams. This can reduce the potential for damage over time, potentially enhancing the overall lifetime of the material by an amount that is directly proportional to the times during which the laser is allowed to enter a “stand-by” mode. At the same time it is preferred that the pump beam not be entirely turned off during these intervals because of issues related to warm up time. This can be accomplished by maintaining the pump beam power but eliminating the overlap between the pump and intracavity beams either spatially or by blocking the pump beam.

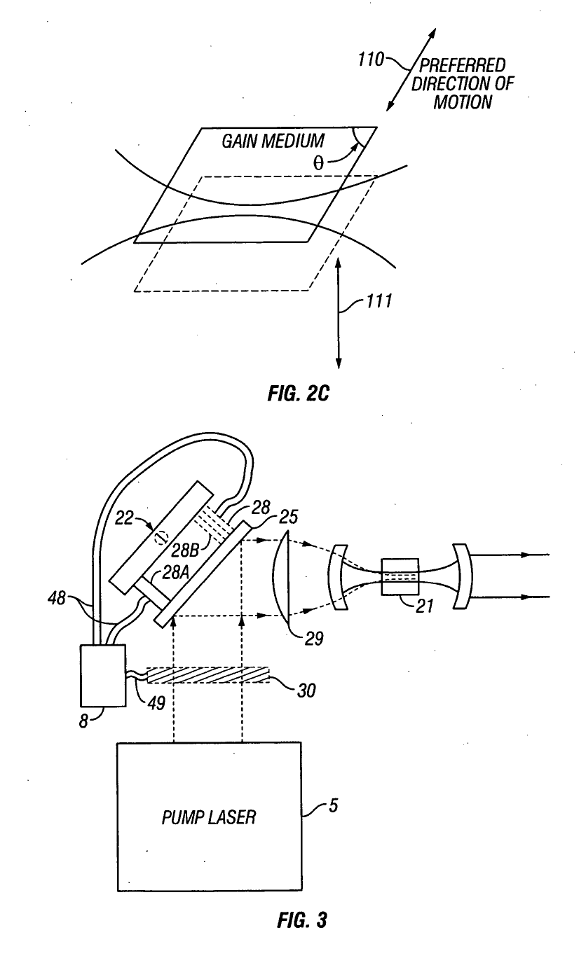

FIGS. 2A-C schematically show the relative locations of the beams' profiles on the rod's surface 99 and the options for deflecting, blocking or translating one or more beams relative to their original positions. Thus in a preferred spot 100, the intracavity beam profile 101 and the pump beam 102 are aligned for maximum gain. For a tunable laser such as Ti:sapphire pumped by visible radiation from either an Ar ion or a frequency doubled Nd laser, the optimal mode matching requires that the pump beam diameter be smaller than that of the intracavity beam, as was described, for example, by Alfrey in U.S. Pat. No. 4,894,831, which is incorporated by reference herein. In this case, it is relatively straightforward to spatially misalign the pump beam so that it no longer overlaps with the intracavity beam as shown schematically in FIG. 2A by new pump beam spot 102′.

By application of such a deflection, the gain for the intracavity beam drops to below the lasing threshold level, and the preferred spot 100 on the optical face of the gain medium is not illuminated by either beam for a set duration of time during which the laser is “off”, formed by the beam profile of the intracavity beam is not illuminated by both beams (with the pump beam deflected and the lasing interrupted). Any particles or molecules trapped by the focused pump beam would be driven away from the preferred spot to the alternative spot 102′. Thus, during the “dark” period of time when the pump beam is deflected, contaminants are not accumulating in the critical spot on the crystal optical face due to trapping. This period of time therefore corresponds effectively to a “stand by” mode for the laser because stable laser operation can be established very quickly, simply by returning the deflected pump spot back to its optimal orientation, where it overlaps the intracavity mode, allowing lasing to commence. The “stand by” mode has the advantage that the pump laser can be kept at full operating condition, thereby avoiding undesirable changes in the pump laser operating characteristics that typically accompany warm-up period, including fluctuations in the pump mode, divergence, power or noise.

FIG. 3 shows an embodiment of a laser system including pump beam guidance means to deflect the pump beam in response to a feedback signals 48 from controller 8. The pump beam is guided into resonator by reflecting off a properly coated mirror 25 and transmission through lens 29 which focuses it into the gain material. The mirror is held in a mount 22 (schematically indicated as a block) that provides tilt control through use of voltage controlled linear actuators 28, 28A and 28C (represented by dotted lines), which may comprise, in a preferred embodiment piezo-electric (PZT) mechanisms. Typically, PZT activated mirrors utilize three actuators, balance over the mirror's surfaces one of which may be fixed. However, arrangements are known where more actuators are used and these all fall within the scope of the invention. The tilt control may be used optimize the positioning of the focused pump beam relative to the intracavity beam of the optically pumped laser where they overlap in the gain medium 21. Optimization of the pump beam position can be accomplished by applying either a dither signal to the voltage controlled actuators and providing feedback to the actuators to orient the mirror so as to maximize the output laser power (for fixed input pump power) or to minimize the pump laser required (for fixed output power). Such PZT driven mirror is provided as a feature in standard a standard laser pumped Ti:sapphire. Therefore, it requires only minor adjustments to the feedback control loop to allow the same mirror holder and actuators to deflect the pump beam such that the laser can enter the preferred “stand-by” mode by reducing the overlap between the pump and intracavity beams. Such a technique will fulfil the requirement of providing a life saver mode using simple modifications of existing hardware and minimizing the complexity of any new software.

An alternative way to create a “standby” mode is to use a remotely-controlled shutter to block the pump beam. By closing the shutter (and thereby blocking the pump beam) during times when the laser beam is not used, the gain material is spared additional unnecessary irradiation. The degradation process is thereby slowed and overall lifetime increases. This embodiment is also shown schematically in FIG. 3 where optional shutter 30 is shown as responsive to feedback signals 49 from controller 8. With a shutter, care must however be taken to insure that the material for the shutter has good heat handling characteristics so it does not contribute to contamination due to particle vaporization. It is also important to assure that any heat trapped in holding off the pump beam will not lead to unacceptable thermal gradients in the air surrounding the shutter, as the gradients may lead to pump beam instabilities after the shutter is opened again.

For further increases in the lifetime of a critical element contained within a sealed system additional means must be employed to slow down the degradation of sensitive materials over long periods of use. One approach is to use an actuator and an appropriately configured translation stage to move the optical surface of the gain medium such that a new unexposed portion is illuminated by the beam profile of the intracavity beam, once the previous spot was used up. In a sealed system this can be accomplished by using a remotely controlled actuator or by a manual drive mechanism that maintains the integrity of the sealed housing. Schematically, such linear translation to a new spot was indicated in FIGS. 2B and 2C by directional line 105 and 110, respectively. While the translation bears superficial similarity to techniques previously used for prolonging the lifetime of nonlinear element, the challenge in the case of a laser pumped medium located within a resonant cavity lies in maintaining optimal mode matching between the pump and all circulating intracavity beams during the translation while requiring only minimal adjustments to the laser cavity itself. This can be especially difficult when the gain medium is, for example, oriented at near Brewster angle relative to the incident intracavity and pump beams. As was indicated in FIG. 2C, it is essential in systems employing translation of a spot across the face of a Brewster cut to move the medium in a direction parallel to the rod's face, as shown by the preferred direction of motion 110. Alternative directions such as 111, cause a shift of the beam's waist relative to the rod's entrance face, which can affect laser operational parameters including the mode quality as well the distribution of the thermal lens. By translating along the preferred direction 110, the waist locations of the pump and intracavity beams(s) are not affected and optimal laser performance is maintained.

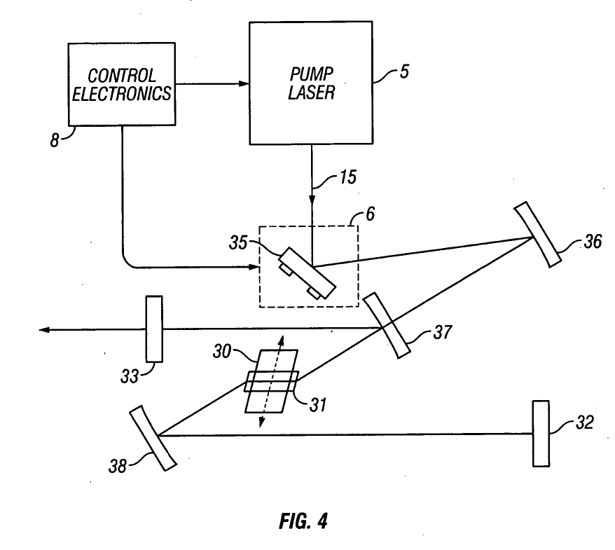

In a laser system designed to extend the operational lifetime of sensitive gain and other optical materials both the life saver mode and the translation to new spots may be implemented. An example of an embodiment incorporating linearly translatable Brewster cut tunable laser material such as Ti:sapphire, and an actuator driven pump mirror is shown in FIG. 4. In this embodiment a Brewster cur rod 31 sits in a heat sink mounted on movement member schematically indicated by numeral 40. In preferred embodiment the movement member comprises a translation stage that is responsive to external commands, as is known in the art of commercial lasers. The Brewster angle is provided only by way of illustration, as the gain medium may be cut at some other preferred angle, depending on the specifics of the application. Pump beam 15 from pump laser 5 is incident on actuator controlled tilted mirror 35 which is coated for reflection at the pump beam wavelength. The beam may be folded again by reflecting off curved mirror 36 followed by transmission through dichroic mirror 37 which is coated for reflection at the resonating wavelength and transmission at the pump wavelength. Another intracavity focusing mirror 38 may be provided by way of illustration, as part of the resonator to provide additional focusing flexibility. The resonator is defined by high reflecting mirror 32 and a partially reflecting mirror 33 providing the outcoupling. Folding mirrors 36 and 38, pump mirror 37 And resonator mirrors 32 and 33 are provided by way of illustration only, without limitation.

In the case of a Ti:sapphire laser, the pump laser may comprise the CW, pulsed or mode locked beams from a nd-doped laser such as is known in the art of solid state laser design. Alternatively, the pump laser may comprise a CW Ar ion laser. The specific optical configurations may also be adapted for other tunable laser media such as Cr:LiSAF, Co:MgF2, Fosterite, or the recently developed Ce-doped gain media, which are pumped in the UV. Still other embodiments of laser pumped configurations include Mid-IR Hodoped lasers pumped by long pulse radiation from a Cr:LisSAF laser as well as laser systems containing intracavity nonlinear elements such as Raman shifters and OPO's in addition to the gain medium.

Additional methods and devices of addressing the long term degradation issue include but are not limited to techniques to reduce the density of particles and molecular contaminants by proper selection of materials, implementing procedures for maintaining a high degree of cleanliness and the judicious use of a purge system. By way of illustration, and without limitation, a purge system similar to the one taught by Herbst et al in U.S. Pat. No. 4,977,566 can be utilized. In particular, continual replacement of the air in the sealed housing containing the laser system can be highly effective in reducing the degradation rate of sensitive optical elements. The recirculating purge system may include an external supply of filtered and pressurized air, Nitrogen or inert gas. Alternatively, it may comprise an air pumping mechanism and a filter system for removing particulate and various molecular contaminants.

All these techniques can be combined with one or more elements of the life saver mode of the present invention to extend the lifetime of an optical element contained within a sealed housing by at least one or more orders of magnitude. This is a significant achievement for the higher average power laser systems that produce radiation with unique features such as tenability, short pulse or the ability to operate in new and more difficult spectral regimes such as in the UV or the mid IR.

The foregoing description of various embodiments of the invention has been presented for purposes of illustration and description. It is not intended to limit the invention to the precise forms disclosed. Many modifications and equivalent arrangements will be apparent.

1. A laser system, comprising:
an output coupler and a high reflector that define a resonator cavity;
a gain medium positioned in the resonator cavity, the gain medium producing an intracavity beam in response to a focused pump beam;
the gain medium having an optical face with a preferred region where the pump beam overlaps optimally with the intracavity beam;
a gain medium movement member coupled to the gain medium and configured to move the preferred region in a direction parallel to the pumped face so as to maintain optimal mode matching conditions.

2. The system of claim 1, wherein the gain medium movement member provides movement of the gain medium at an angle that is the same angle as an angle of the optical face.

3. The system of claim 3, wherein the angle of the optical face is cut at Brewsters angle.

4. The system of claim 1, wherein the gain medium is made of Ti:sapphire.

5. A laser system, comprising:
an output coupler and a high reflector that define a resonator cavity;
a gain medium positioned in the resonator cavity, the gain medium having an optical face for a pump beam with a preferred pump beam face region on the optical face;
the gain medium producing an intracavity beam in response to an incident pump beam;
the intracavity beam being focused by the resonator cavity to a region overlapping with the incident pump beam in a preferred pump beam face region;
a rotatable mirror positioned to receive a pump beam and move it from the preferred pump beam face region and out of the path of the intracavity beam to thereby interrupt lasing during periods when it is not required.

6. A laser system, comprising:
an output coupler and a high reflector that define a resonator cavity;
a gain medium positioned in the resonator cavity, the gain medium having an optical face for a pump beam with a preferred pump beam face region on the optical face;
the gain medium producing an intracavity beam in response to an incident pump beam;
the intracavity beam being focused by the resonator cavity to a region overlapping with the incident pump beam in a preferred pump beam face region;
shutter is positioned to interrupt passage of a pump beam in the resonator cavity to the preferred pump beam face region.
